(19) United States
(12) Patent Application Publication
(10) Pub. No.: US 2007/0184232 A1
(43) Pub. Date: Aug. 9, 2007

(54) Optical recording materials having high storage density

(76) Inventors: Ryuichi Takahashi, Hyogo (JP); Kazuhiko Kunimoto, Hyogo (JP); Peter Sutter, Sissach (CH); Urs Lehmann, Basel (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/590,192

(22) PCT Filed: Feb. 16, 2005
(86) PCT No.: PCT/EP05/50670

§ 371 Date: Aug. 21, 2006

(30) Foreign Application Priority Data
Feb. 23, 2004 (EP) 2004/050185
Aug. 18, 2004 (EP) 04103948.8

(51) Int. Cl. B32B 3/02

(52) U.S. Cl. 428/64.4

(57) ABSTRACT

The invention relates to an optical recording medium comprising a substrate, a reflecting layer and a recording layer comprising a compound of formula (I) or a tautomer thereof, wherein G₁, G₂ and G₃ are each independently of the other A₁, A₂ and A₃ are each independently of the other N(R₁₄),O, S or Se and A₄ is C(C₁-C₅aIkyl)2, C(C₄-C₅alkylene), N(R₁₄), O, S, Se, N═C(R₁₅) or CH═C(R₁₆); M₁ is an at least trivalent metal of groups 3 to 15 most preferred Co(III) or Cr(III); Q₁, Q₂ and Q₃ are each independently of the other C(R₁₇), N or P. Recording and playback are effected especially at a wavelength of from 350 to 500 nm, for example using a blue laser.

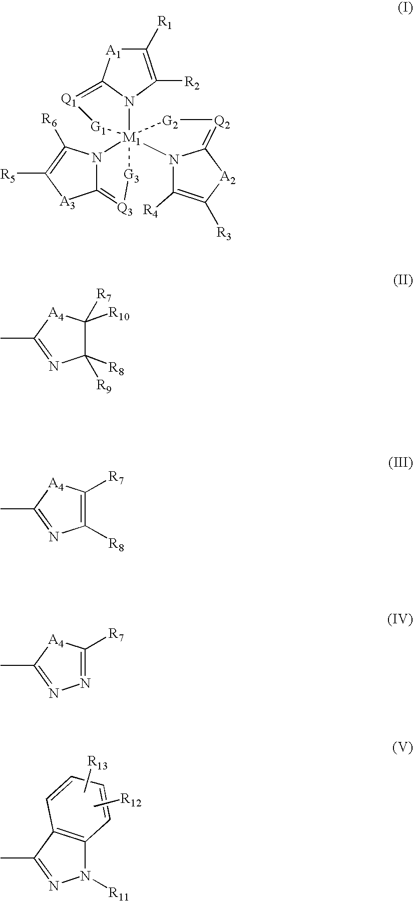

The invention relates to new optical recording materials that have excellent recording and playback quality especially at a wavelength of 350-500 nm. Recording and playback can be effected very advantageously with high sensitivity at the same wavelength, and the storage density that is achievable is significantly higher than in the case of known materials. In addition, the materials according to the invention have very good storage properties before and after recording, even under especially harsh conditions, such as exposure to sunlight or fluorescent lighting, heat and/or high humidity. In addition, their manufacture is simple and readily reproducible using customary coating processes, such as spin-coating.

WO 02/082 438 discloses the use of ionic salts, including those with metal complex anions, for optical recording materials. Those colorants are always substituted by alkyl, alkenyl, aryl or heteroaryl at the nitrogen atom. Their optical properties do not, however, fully satisfy increased demands. In particular, the refractive index as well as the absorption and the steepness of the absorption band on its long wavelength flank in the solid still leave something to be desired.

JP-A-11/34 500, JP-A-11/92 479 and EP-A-0 903 733 disclose metal and boron complexes of colorants of formulae 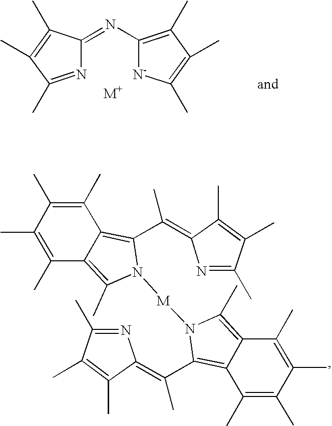
which can be used at from 520 to 690 nm for optical recording materials such as CD-R or DVD-R. Here too, however, the optical properties, especially the spectral properties in or near the UV range that are necessary for the highest possible storage densities, and the information density per unit surface area are not able to satisfy the highest demands as desired. The information density per unit surface area is far lower than is desirable.

Conventional optical recording materials therefore satisfy high demands only to some extent, or do not satisfy all demands to an entirely satisfactory degree at the same time.

J. Org. Chem. 67/16, 5753-5772 [2002] describes the synthesis of a number of bis(o-azaheteroaryl)methanes and their coordination properties with respect to divalent transition metals, heteroaryl being 1,3-azol-2-yl, 1,3-benzazol-2-yl and azinyl and the transition metals being Zn⁺⁺, Cu⁺⁺, Co⁺⁺, Ni⁺⁺, Hg⁺⁺and Pd⁺⁺.

The aim of the invention is an optical recording medium having high information density, sensitivity and data reliability. Such a recording medium should be robust, durable and easy to use. Furthermore, it should be inexpensive to manufacture as a mass-produced product and should require equipment that is as small and inexpensive as possible.

The invention therefore relates to an optical recording medium comprising a substrate, a recording layer and optionally one or more reflecting layers, wherein the recording layer comprises a compound of formula 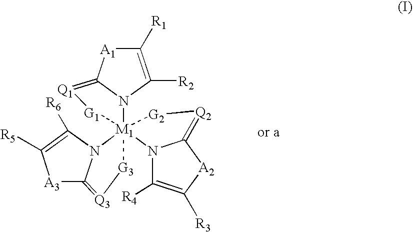
tautomer thereof, wherein G₁, G₂ and G₃ are each independently of the other

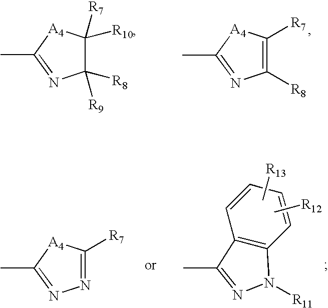

A₁, A₂ and A₃ are each independently of the other N(R₁₄), O, S or Se and A₄ is C(C₁-C₅alkyl)₂, C(C₄-C₅alkylene), N(R₁₄), O, S, Se, N═C(R₁₅) or CH═C(R₁₆);

M₁ is an at least trivalent metal of groups 3 to 15 [formerly groups IIIA to VB], preferably Co(III), Cr(III), Ru(III), Fe(III), Mn(III), V(III), Ti(III), Y(III), Mo(III), W(III), Nb(III), Rh(III), Ta(III), Ir(III), Au(III), Al(III), As(III), Sb(III), Bi(III), Sc(III), La(III), Ce(III), Pr(III), Nd(III), Pm(III), Sm(III), Eu(III), Gd(III), Tb(III), Dy(III), Ho(III), Er(III), Tm(III), Yb(III) or Lu(III), most preferred Co(III) or Cr(III);

Q₁, Q₂ and Q₃ are each independently of the other C(R₁₇), N or P;

R₁, R₂, R₃, R₄, R₅, R₆, R₇, R₈, R₉, R₁₀ and R₁₆ are each independently of the others hydrogen, R₁₈, or C₆-C₁₂aryl, C₄-C₁₂heteroaryl, C₇-C₁₂aralkyl or C₅-C₁₂heteroaralkyl each unsubstituted or substituted by one or more, where applicable identical or different, radicals R₁₈; or

R₁ and R₂, R₃ and R₄, R₅ and R₆, R₇ and R₈, R₇ and R₁₅ and/or R₇ and R₁₆, together in pairs, are C₃-C₆alkylene or C₃-C₆alkenylene, each of which is unsubstituted or substituted by one or more, where applicable identical different, radicals R₁₉ and may be uninterrupted or interrupted by O, S or N(R₁₄), or 1,4-buta-1,3-dienylene, 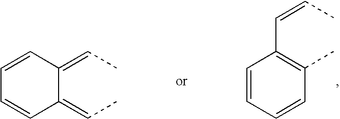
each of which is unsubstituted or substituted by one or more, where applicable identical or different, radicals R₁₈ and in which 1 or 2 carbon atoms may have been replaced by nitrogen;

R₁₁, R₁₄ and R₁₅ are each independently of the others C₁-C₂₄alkyl, C₃-C₂₄cycloalkyl, C₂-C₂₄alkenyl, C₃-C₂₄cycloalkenyl, C₁-C₄alkyl-[O-C₁-C₄alkylene]ₘ or C₁-C₄alkyl-[NH-C₁-C₄alkylene]ₘ, each of which is unsubstituted or substituted by one or more, where applicable identical or different, radicals R₁₉; or C₆-C₁₂aryl, C₄-C₁₂heteroaryl, C₇-C₁₂aralkyl or C₅-C₁₂heteroaralkyl, each of which is unsubstituted or substituted by one or more, where applicable identical or different, radicals R₁₈;

R₁₂, R₁₃ and R₁₈ are each independently of the others R₂₀ or C₁-C₁₂alkyl, C₃-C₁₂cycloalkyl, C₁-C₁₂alkylthio, C₃-C₁₂cycloalkylthio, C₁-C₁₂alkoxy or C₃-C₂cycloalkoxy each unsubstituted or substituted by one or more, where applicable identical or different, radicals R₁₉;

R₁₇ is hydrogen, halogen, cyano, hydroxy, C₁-C₁₂alkoxy, C₃-C₁₂cycloalkoxy, C₁-C₁₂alkylthio, C₃-C₁₂cycloalkylthio, amino, nitro, formyl, C(R₁₆)═CR₂₁R₂₂, C(R₁₆)═NR₂₃, N═CR₂₃R₂₄, NHR₂₅, NR₂₆R₂₇, COO—R₂₆, carboxy, carbamoyl, CONH—R₂₆, CONR₂₆R₂₇, R₂₈, N═N—R₂₈ or R₂₉;

R₁₉ is halogen, hydroxy, O—R₂₆, O—CO—R₂₆, S—R₂₆, NH₂, NH—R₂₆, NR₂₆R₂₇, NH₃⁺, NH₂R₂₆⁺, NHR₂₆R₂₇⁺, NR₂₅R₂₆R₂₇⁺, NR₂₆—CO—R₂₅, NR₂₆COOR₂₅, cyano, formyl, COO—R₂₆, carboxy, carbamoyl, CONH—R₂₆, CONR₂₆R₂₇, ureido, NH—CO—NHR₂₅, NR₂₆—CO—NHR₂₅, phosphato, PR₂₅R₂₆, POR₂₅OR₂₆, P(═O)OR₂₅OR₂₆, OPR₂₅R₂₆, OPR₂₅OR₂₆, OP(═O)R₂₅OR₂₆, OPO₃R₂₆, OP(═O)OR₂₅OR₂₆, SO₂R₂₆, sulfato, sulfo, R₂₈, N═N═R₂₈, or C₁-C₁₂alkoxy or C₁-C₂cycloalkoxy each unsubstituted or mono- or poly-substituted by halogen;

R₂₀ is halogen, nitro, cyano, thiocyanato, hydroxy, O—R₂₃, O—CO—R₂₃, S—R₂₃, CHO, COR₂₄, CHOR₂₃OR₃₀, CR₂₄OR₂₃OR₃₀, R₃₁, N═N—R₃₁, N═CR₂₃R₂₄, N═CR₂₁R₂₂, C(R₃₂)═NR₂₃, C(R₃₂)═NR₂₁, C(R₃₂)═CR₂₁R₂₂, NH₂, NH—R₂₃, NR₂₃R₂₄, NH₃⁺, NH₂R₂₃⁺, NHR₂₃R₂₄⁺, NR₂₃R₂₄R₃₀⁺, CONH₂, CONHR₂₃, CONR₂₃R₂₄, SO₂R₂₃, SO₂NH₂, SO₂NHR₂₃, SO₂NR₂₃R₂₄, COOH, COOR₂₃, OCOOR₂₃, NHCOR₂₃, NR₂₃COR₃₀, NHCOOR₂₃, NR₂₃COOR₃₀, ureido, NR₂₃—CO—NHR₃₀, B(OH)₂, B(OH)(OR₂₃), B(OR₂₃)OR₃₀, phosphato, PR₂₃R₃₀, POR₂₃OR₃₀, P(═O)OR₂₃OR₃₀, OPR₂₃R₃₀, OPR₂₃OR₃₀, OP(═O)R₂₃OR₃₀, OP(═O)OR₂₃OR₃₀, OPO₃R₂₃, sulfato or sulfo;

R₂₁ and R₂₂ are each independently of the other NR₂₆R₂₇, CN, CONH₂, CONHR₂₃, CONR₂₃R₂₄,or COOR₂₄;

R₂₃, R₂₄ and R₃₀ are each independently of the others R₃₁, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals; or

R₁₆ and R₂₃ together, R₁₇ and R₂₃ together and/or R₂₃ and R30 together are C₂-C₁₂alkylene, C₃-C₁₂cycloalkylene, C₂-C₁₂alkenylene or C₃-C₁₂cycloalkenylene, each of which is unsubstituted or substituted by one or more, where applicable identical or different, halogen, hydroxy, C₁-C₁₂alkoxy or C₃-C₁₂cycloalkoxy radicals; or

R₂₃ and R₂₄ together with the common nitrogen are pyrrolidine, piperidine, piperazine or morpholine, each of which is unsubstituted or mono- to tetra-substituted by C₁-C₄alkyl; or carbazole, phenoxazine or phenothiazine, each of which is unsubstituted or substituted by one or more, where applicable identical or different, radicals R₃₃;

R₂₅, R₂₆ and R₂₇ are each independently of the others C₁-C₁₂alkyl, C₃-C₂cycloalkyl, C₂-C₁₂alkenyl, C₃-C₁₂cycloalkenyl, C₆-C₁₂aryl, C₄-C₁₂heteroaryl, C₇-C₁₂aralkyl or C₅-C₁₂heteroaralkyl; or

R₂₆ and R₂₇ together with the common nitrogen are pyrrolidine, piperidine, piperazine or morpholine, each of which is unsubstituted or mono- to tetra-substituted by C₁-C₄alkyl;

R₂₈ is C₆-C₁₂aryl, C₄-C₁₂heteroaryl, C₇-C₁₂aralkyl or C₅-C₁₂heteroaralkyl, each of which is unsubstituted or substituted by one or more, where applicable identical or different, radicals R₂₀ or R₂₉;

R₂₉ is C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals;

R₃₁ is C₆-C₁₂aryl, C₄-C₁₂heteroaryl, C₇-C₁₂aralkyl or C₅-C₁₂heteroaralkyl, each of which is unsubstituted or substituted by one or more, where applicable identical or different, radicals R₃₃;

R₃₂ is hydrogen, cyano, hydroxy, C₁-C₁₂alkoxy, C₃-C₁₂cycloalkoxy, C₁-C₁₂alkylthio, C₃-C₁₂cycloalkylthio, amino, NHR₂₅, NR₂₆R₂₇, R₂₈, halogen, nitro, formyl, N═N—R₂₈, COO—R₂₆, carboxy, carbamoyl, CONH—R₂₆, CONR₂₆R₂₇, N═CR₂₃R₂₄, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals;

R₃₃ is nitro, SO₂NHR₂₆ SO₂NR₂₆R₂₇, or C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each unsubstituted or substituted by one or more, where applicable identical or different, radicals R₁₉; and

m is a number from 1 to 10.

When R₇ forms a bridge with R₈, R₇ preferably does not at the same time form a bridge with R₁₅ or R₁₆.

The compounds of formula (I) have a non-planar coordination geometry generally leading upon synthesis to mixtures of isomers, which are useful as such. The single isomers, easily obtainable by usual separation methods, as well as compounds of formula (I) lacking isomers due to their high symmetric ligands, are all also suitable for the instant purpose and objects of the invention, too.

It is believed that G₁, G₂ and G₃ coordinate to the metal at their nitrogen atom: 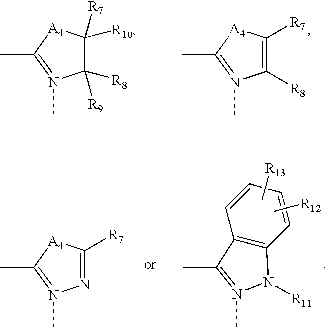
However, when A₄ is N(R₁₄), O, S or Se, or when Q₁, Q₂ or Q₃ are N or P, it is also possible for A₄, Q₁, Q₂ and/or Q₃ to coordinate with the metal, thus leading to further isomery. Though preferred, it is not even necessary for G₁, G₂ and G₃ to be coordinated with the metal.

Independently from or in combination with any other preferences such as disclosed below, R₂, R₄, R₆, R₈, R₉ and/or R₁₁ are preferably independently of each other hydrogen; most preferred, all of R₂, R₄, R₆, R₈, R₉ and R₁₁ are hydrogen in formula (I). This appears to facilitate the formation and to enhance the stability of the compounds of formula (I). Thus, the invention also pertains to compounds of formula (I) wherein R₂, R₄, R₆, R₈, R₉ and R₁₁ are hydrogen and their use for optical recording.

It will be understood that acidic groups, such as carboxy, sulfo, sulfato and phosphate, may also be in the form of a salt, for example an alkali metal, alkaline earth metal, ammonium or phosphonium salt, such as Li⁺, Na⁺, K⁺, Mg²⁺, Ca²⁺, Cu²⁺, Ni²⁺, Fe²⁺, Co²⁺, Zn²⁺, Sn²⁺, La³⁺, ammonium, methylammonium, ethylammonium, isopropylammonium, ™Primene 81-R, ™Rosin Amine D, pentadecylammonium, ™Primene JM-T, dicyclohexylammonium, tetramethylammonium, tetraethylammonium, tetrabutylammonium, benzyltrimethylammonium, benzyltriethylammonium, methyltrioctylammonium, tridodecylmethylammonium, tetrabutylphosphonium, tetraphenylphosphonium, butyltriphenylphosphonium or ethyltriphenylphosphonium, or any of the cations B-1 to B-169 mentioned in U.S. Pat. No. 6,225,024, to which individually reference is expressly made here.

Halogen is chlorine, bromine, fluorine or iodine, preferably fluorine, bromine or chlorine, especially fluorine on alkyl (for example trifluoromethyl, α,α,α-trifluoroethyl or perfluorinated alkyl groups, such as heptafluoropropyl) and chlorine or bromine on aryl, heteroaryl or on the aryl moiety of aralkyl or on the heteroaryl moiety of heteroaralkyl.

Alkyl, cycloalkyl, alkenyl or cycloalkenyl can be straight-chain or branched, or monocyclic or polycyclic. Alkyl is, for example, methyl, straight-chain or branched C₂-C₂₄alkyl, preferably C₁-C₄alkyl, in particular methyl, ethyl or isopropyl. Alkenyl is, for example, straight-chain or branched C₂-C₂₀alkenyl, preferably C₂-C₃alkenyl, in particular vinyl, allyl or 2-propylen. The invention therefore relates especially also to compounds of formula (I) containing C₁-C₄alkyl or C₂-C₃alkenyl, and also to optical recording materials comprising such compounds. These preference is independent from the position of C₂-C₂₄alkyl or C₂-C₂₀alkenyl in Formula (I).

C₁-C₂₄Alkyl is, for example, methyl, ethyl, n-propyl, isopropyl, n-butyl, sec-butyl, isobutyl, tert-butyl, n-pentyl, 2-pentyl, 3-pentyl, 2,2-dimethylpropyl, n-hexyl, n-octyl, 1,1,3,3-tetramethylbutyl, 2-ethylhexyl, nonyl, decyl, dodecyl, tetradecyl, hexadecyl, octadecyl, eicosyl, heneicosyl, docosyl or tetracosyl. C₃-C₂₄Cycloalkyl is, for example, cyclopropyl, cyclobutyl, cyclopentyl, cyclohexyl, trimethylcyclohexyl, menthyl, thujyl, bornyl, 1-adamantyl or 2-adamantyl, preferably cyclopropyl, cyclobutyl, cyclopentyl or cyclohexyl.

C₂-C₂₀Alkenyl and C₃-C₂₀cycloalkenyl are C₂-C₂₀alkyl and C₃-C₂₀cycloalkyl that is mono- or poly-unsaturated, wherein two or more double bonds may be isolated or conjugated, for example vinyl, allyl, 2-propen-2-yl, 2-buten-1-yl, 3-buten-1-yl, 1,3-butadien-2-yl, 2-cyclobuten-1-yl, 2-penten-1-yl, 3-penten-2-yl, 2-methyl-1-buten-3-yl, 2-methyl-3-buten-2-yl, 3-methyl-2-buten-1-yl, 1,4-pentadien-3-yl, 2-cyclopenten-1-yl, 2-cyclohexen-1-yl, 3-cyclohexen-1-yl, 2,4-cyclohexadien-1-yl, 1-p-menthen-8-yl, 4(10)-thujen-10-yl, 2-norbornen-1-yl, 2,5-norbomadien-1 -yl, 7,7-dimethyl-2,4-norcaradien-3-yl or the various isomers of hexenyl, octenyl, nonenyl, decenyl, dodecenyl, tetradecenyl, hexadecenyl, octadecenyl, eicosenyl, heneicosenyl, docosenyl, tetracosenyl, hexadienyl, octadienyl, nonadienyl, decadienyl, dodecadienyl, tetradecadienyl, hexadecadienyl, octadecadienyl or eicosadienyl.

C₇-C₁₂Aralkyl is, for example, benzyl, 2-benzyl-2-propyl, β-phenyl-ethyl, 9-fluorenyl, α,α-dimethylbenzyl, ω-phenyl-butyl or ω-phenyl-hexyl. When C₇-C₁₂aralkyl is substituted, both the alkyl moiety and the aryl moiety of the aralkyl group can be substituted, the latter alternative being preferred.

C₆-C₁₂Aryl is, for example, phenyl, naphthyl, biphenylyl or 2-fluorenyl.

C₄-C₁₂Heteroaryl is an unsaturated or aromatic radical having 4n+2 conjugated π-electrons, for example 2-thienyl, 2-furyl, 2-pyridyl, 2-thiazolyl, 2-oxazolyl, 2-imidazolyl, isothiazolyl, triazolyl or any other ring system consisting of thiophene, furan, pyridine, thiazole, oxazole, imidazole, isothiazole, triazole, pyridine and benzene rings and unsubstituted or substituted by from 1 to 6 ethyl, methyl, ethylene and/or methylene substituents, for example benzotriazolyl, and in the case of N-heterocycles where applicable also those in the form of their N-oxides.

C₅-C₁₂Heteroaralkyl is, for example, C₁-C₈alkyl substituted by C₄-C₁₁heteroaryl.

Furthermore, aryl and aralkyl can also be aromatic groups bonded to a metal, for example in the form of metallocenes of transition metals known per se, more especially

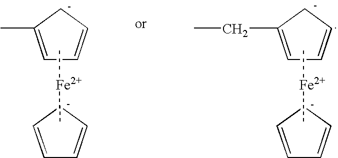

The metal M₁ is preferably in the form of a trebly positively charged cation, for example Co³⁺, Cr³⁺, Ru³⁺, Fe³⁺, Mn³⁺, Au³⁺, Al³⁺, Sb³⁺, Bi³⁺, Sc³⁺, La³⁺ or Ce³⁺, Most preferred Co³⁺ or Cr³⁺.

The compound of formula (I) may also be a cation which has been neutralised with an inorganic, organic or organometallic anion, for example when one or more ammonium groups are present or when the metal M₁ has one or more excess positive charges, such as in Ti⁴⁺, Zr⁴⁺ or V⁵⁺; non-exhaustive examples thereof are Ti(Cl)³⁺, Zr(OH)³⁺ or VO³⁺. Compounds of formula (I) wherein M₁ has one or more excess positive charges may also be zwitter ions, with anionic substituents in the ligands of formula (I).

The inorganic, organic or organometallic anion may be, for example, the anion of a mineral acid, of the conjugated base of an organic acid (for example an alcoholate, phenolate, carboxylate, sulfonate or phosphonate) or an organometallic complex anion, for example fluoride, chloride, bromide, iodide, perchlorate, periodate, nitrate, hydrogen carbonate, ½ carbonate, ½ sulfate, C₁-C₄alkyl sulfate, hydrogen sulfate, ⅓ phosphate, ½ hydrogen phosphate, dihydrogen phosphate, ½ C₁-C₄alkanephosphonate, C₁-C₄alkane-C₁-C₁₂alkylphosphonate, di-C₁-C₄alkylphosphinate, tetrafluoroborate, hexafluorophosphate, hexafluoroantimonate, acetate, trifluoroacetate, heptafluorobutyrate, ½ oxalate, methanesulfonate, trifluoromethanesulfonate, benzenesulfonate, tosylate, p-chlorobenzenesulfonate, p-nitrobenzenesulfonate, phenolate, benzoate or a negatively charged metal complex.

The person skilled in the art will readily recognise that it is also possible to use other anions with which he is familiar. It will be self-evident to him that 1/x of an inorganic, organic or organometallic anion having x negative charges, for example 1/2·SO₄²⁻, is a multiply charged anion which neutralises several singly charged cations or a cation having x charges, as the case may be.

Phenolates or carboxylates are, for example, of formula 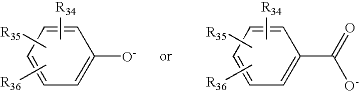
(wherein R₃₄, R₃₅ and R₃₆ are each independently of the others hydrogen, R₁₈, or C₆-C₁₂aryl, C₄-C₁₂heteroaryl, C₇-C₁₂aralkyl or C₅-C₁₂heteroaralkyl each unsubstituted or substituted by one or more, where applicable identical or different, radicals R₁₈, for example anions of C₁-C₁₂alkylated, especially tert-C₄-C₈alkylated, phenols and benzoic acids, such as

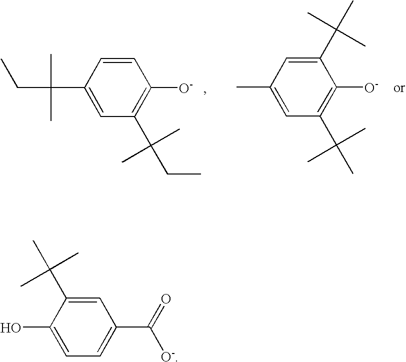

Preferably, however, the compounds of formula (I) are neutral and either zwitterionic or in particular non-ionic, so that no additional counter-ions are necessary.

In particular, preference is given to compounds of formula (I) wherein

A₁, A₂, A₃ and A₄ are each independently of the others O, S or N(R₁₄) and/or Q₁, Q₂ and Q₃ are C(R₁₇) or N;

G₁, G₂ and G₃ are each independently of the other

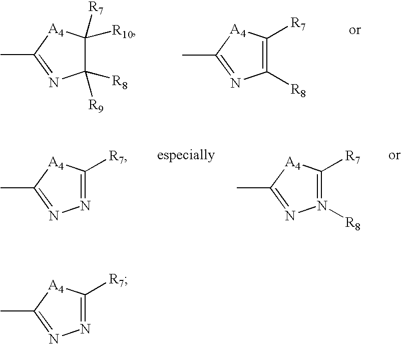

R₁, R₃, R₅, R₇, R₁₀ and R₁₆ are each independently of the others hydrogen, R₁₈, or C₆-C₁₂aryl or C₇-C₁₂aralkyl each unsubstituted or substituted by one or more, where applicable identical or different, radicals R₁₈;

R₂, R₄, R₆, R₈ and R₉ are each independently of the others H, F, OH, OCH₃, OCF₃, CH₃, CF₃, C₂H₅, C₂H₂F₃, C₂H₃F₂, C₂F₅, CH₂OH, CF₂OH or CH₂OCH₃;

R₁₄ and R₁₅ are each independently of the others unsubstituted or R₁₉-substituted C₁-C₈alkyl;

R₁₂ and R₁₈ are each independently of the other halogen, nitro, cyano, O—R₂₃, CHO, CH═C(CN)₂, CH═C(CN)CONH₂, CH═C(CN)CONHR₂₃, CH═C(CN)CONR₂₃R₂₄, CH═C(CN)COOR₂₃, CH═C(COOR₂₃)COOR₂₄, CONH₂, CONHR₂₃, CONR₂₃R₂₄, SO₂C₁-C₁₂alkyl, SO₂NH₂, SO₂NHR₂₃, SO₂NR₂₃R₂₄, COOH, COOR₂₃, NHCOR₂₃, NR₂₃COR₃₀, NHCOOR₂₃, NR₂₃COOR₃₀, ureido, P(═O)OR₂₃OR₃₀, sulfo, or C₁-C₁₂alkyl, C₁-C₁₂alkylthio or C₁-C₁₂alkoxy each unsubstituted or substituted by one or more, where applicable identical or different, radicals R₁₉;

R₁₇ is hydrogen, halogen, cyano, nitro, formyl, C(R₁₆)═CR₂₁R₂₂, C(R₁₆)═NR₂₃, COO—R₂₆, carboxy, carbamoyl, CONH-R₂₆, CONR₂₆R₂₇, N═N—R₂₈, or C₁-C₁₂alkyl unsubstituted or substituted by one or more halogen substituents;

R₁₉ is halogen, hydroxy, O—R₂₆, NH₂, NH—R₂₆, NR₂₆R₂₇, NR₂₆—CO—R₂₅, NR₂₆COOR₂₅, cyano, COO—R₂₆, carboxy, CONH—R₂₆, CONR₂₆R₂₇, sulfato, sulfo, or C₁-C₁₂alkoxy unsubstituted or mono- or poly-substituted by halogen;

R₂₃, R₂₄ and R₃₀ are each independently of the others C₁-C₁₂alkyl unsubstituted or substituted by one or more, where applicable identical or different, halogen, hydroxy or C₁-C₁₂alkoxy radicals, or unsubstituted C₆-C₁₂aryl or C₇-C₁₂aralkyl; or

R₂₃ and R₂₄ together with the common nitrogen are morpholine, or piperidine N-substituted by C₁-C₄alkyl;

R₂₅, R₂₆ and R₂₇ are each independently of the others C₁-C₁₂alkyl, C₂-C₁₂alkenyl, C₆-C₁₂aryl or C₇-C₁₂aralkyl; or

R₂₆ and R₂₇ together with the common nitrogen are morpholine, or piperidine N-substituted by C₁-C₄alkyl;

R₃₁ is unsubstituted or substituted C₆C₁₂aryl or C₇-C₁₂aralkyl, especially a metallocenyl radical; and/or

m is a number from 1 to 4.

Special preference is given to compounds of formula (I) wherein Q₁, Q₂ and Q₃ are C(R₁₇); G₁, G₂ and G₃ are 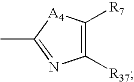
and A₁, A₂, A₃ and A₄ are O, S or N(R₁₄);

R₁₄ is C₁-C₂₄alkyl, C₁-C₄alkyl-[O-C₁-C₄alkylene]ₘ or C₁-C₄alkyl-[NH-C₁-C₄alkylene]ₘ, each of which is unsubstituted or substituted by one or more, where applicable identical or different, radicals R₁₉, or C₆-C₁₂aryl unsubstituted or substituted by one or more, where applicable identical or different, radicals R₁₈;

R₁₇ is hydrogen, cyano, COO—R₂₆ or C₁-C₁₂alkyl;

R₁₈ is halogen, nitro, cyano, O—R₂₃, CH═C(CN)₂, COOR₂₃, ureido, CONR₂₆R₂₇, SO₂R₂₆, P(═O)OR₂₃OR₃₀ or unsubstituted or substituted C₁-C₁₂alkyl;

R₁₉ is halogen, hydroxy, O—R₂₆, cyano, COO—R₂₆ or carboxy; and

R₃₇ is H, methyl, ethyl or isopropyl, in particular H.

Those preferred meanings apply both individually and in any combination. The compounds of formula (I) generally exhibit more advantageous properties, the more preferred individual features they have.

Also preferred are compounds of formula (I) wherein

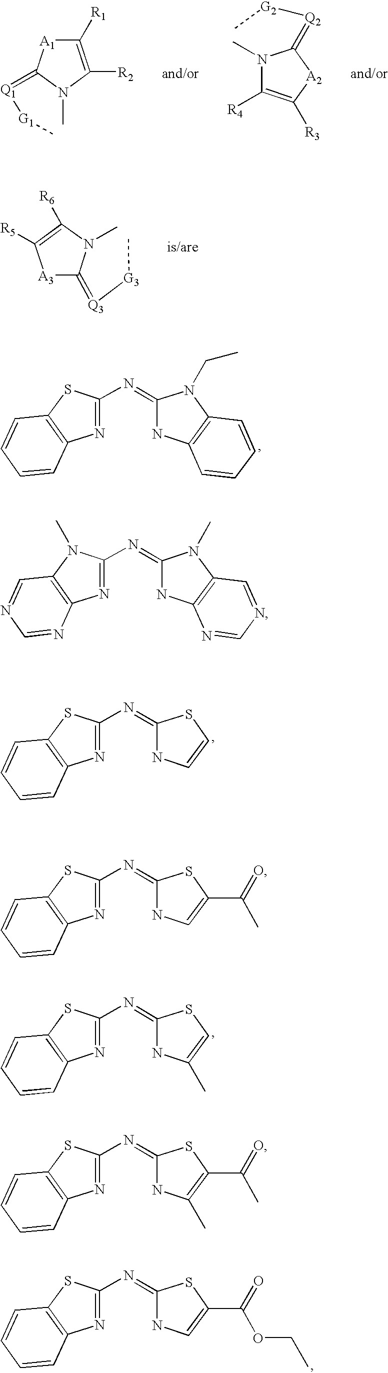

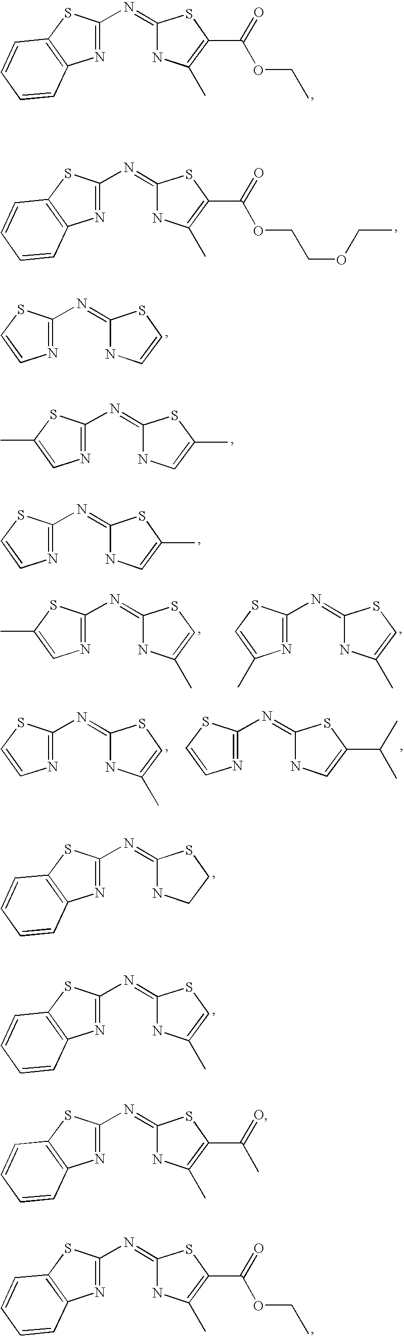

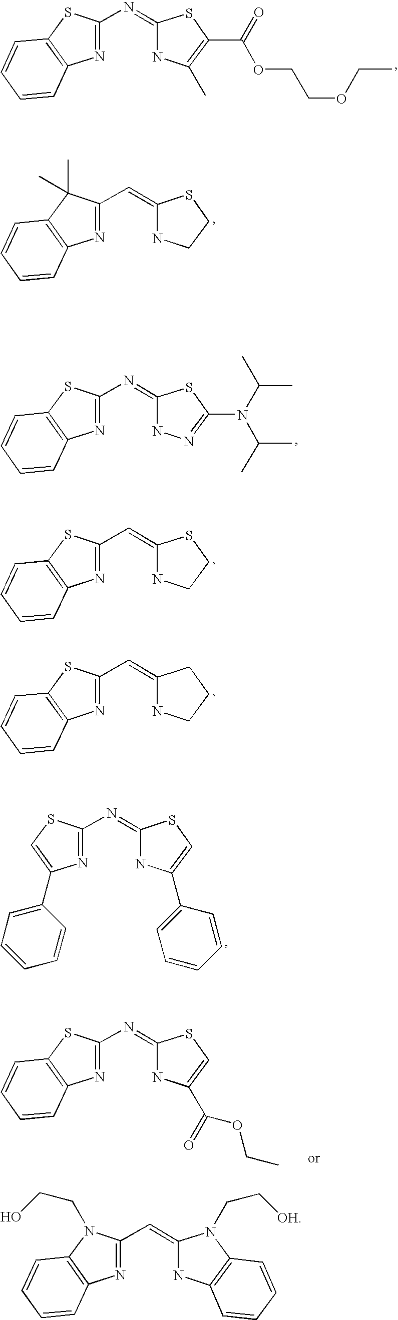

The recording layer advantageously comprises a compound of formula (I) or a mixture of such compounds as main component, for example at least 30% by weight, preferably at least 60% by weight, especially at least 80% by weight. Further customary constituents are possible, for example other chromophores (for example those disclosed in WO 01/75873, or others having an absorption maximum at from 300 to 1000 nm), stabilisers, ¹O₂-, triplet- or luminescence-quenchers, melting-point reducers, decomposition accelerators or any other additives that have already been described in optical recording media. Preferably, stabilisers or fluoresence-quenchers are added if desired.

When the recording layer comprises further chromophores, the amount of such chromophores should preferably be small, so that the absorption thereof at the wavelength of the inversion point of the longest-wavelength flank of the absorption of the entire solid layer is a fraction of the absorption of the pure compound of formula (I) in the entire solid layer at the same wavelength, advantageously at most ⅓, preferably at most ⅕, especially at most 1/10. The absorption maximum is preferably higher than 425 nm, especially higher than 500 nm.

Stabilisers, ¹O₂-, triplet- or luminescence-quenchers are, for example, metal complexes of N- or S-containing enolates, phenolates, bisphenolates, thiolates or bisthiolates or of azo, azomethine or formazan dyes, such as bis(4-dimethylamino-dithiobenzil)nickel [CAS N^{o} 38465-55-3], ®Irgalan Bordeaux EL, ®Cibafast N or similar compounds, hindered phenols and derivatives thereof (optionally also as counter-ions X), such as ®Cibafast AO, o-hydroxyphenyl-triazoles or -triazines or other UV absorbers, such as ®Cibafast W or ®Cibafast P or hindered amines (TEMPO or HALS, also as nitroxides or NOR-HALS, optionally also as counter-ions X), and also as cations diummonium, Paraquat™ or Orthoquat™ salts, such as ®Kayasorb IRG 022, ®Kayasorb IRG 040, optionally also as radical ions, such as N,N,N′,N′-tetrakis(4-dibutylaminophenyl)-p-phenyleneamine-ammonium hexafluorophosphate, hexafluoroantimonate or perchlorate. The latter are available from Organica (Wolfen/DE); ®Kayasorb brands are available from Nippon Kayaku Co. Ltd., and ®Irgalan and ®Cibafast brands are available from Ciba Spezialitätenchemie AG.

Many such structures are known, some of them also in connection with optical recording media, for example from U.S. Pat. No. 5,219,707, JP-A-06/199045, JP-A-07/76169, JP-A-07/262604 or JP-A-2000/272241. They may be, for example, salts of the metal complex anions disclosed above with any desired cations, for example the cations disclosed above, or metal complexes, illustrated, for example, by a compound of formula

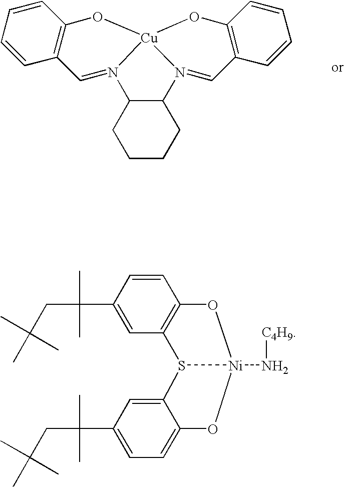

The person skilled in the art will know from other optical information media, or will easily identify, which additives in which concentration are particularly well suited to which purpose. Suitable concentrations of additives are, for example, from 0.001 to 1000% by weight, preferably from 1 to 50% by weight, based on the recording medium of formula (I).

The optical recording materials according to the invention exhibit excellent spectral properties of the solid amorphous recording layer. The refractive index is extraordinarily high, in some cases even above 2.5. By virtue of an aggregation tendency in the solid that is surprisingly low for such compounds, the absorption band is narrow and intense, the absorption band being especially steep on the long-wavelength side. Crystallites are unexpectedly and very advantageously not formed or are formed only to a negligible extent. The reflectvity of the layers in the range of the writing and reading wavelength is very high in the unwritten state.

By virtue of those excellent layer properties it is possible to obtain a rapid optical recording having high sensitivity, high reproducibility and geometrically very precise mark boundaries, the refractive index and the reflectivity changing substantially, which gives a high degree of contrast. The differences in the mark lengths and the interval distances (“jitter”) are very small, which enables a high storage density to be obtained using a relatively thin recording channel with a narrow track spacing (“pitch”). In addition, the recorded data are played back with an astonishingly low error rate, so that error correction requires only a small amount of storage space.

By virtue of the excellent solubility, including in apolar solvents, solutions can be used even in high concentrations without troublesome precipitation, for example during storage, so that problems during spin-coating are largely eliminated. This applies especially to compounds containing branched C₃-C₈alkyl.

Recording and playback can take place at the same wavelength, therefore advantageously requiring a simple optical system with a single laser source of advantageously from 350 to 500 nm, preferably from 370 to 450 nm. Especially preferred is the UV range from 370 to 390 nm, especially approximately 380 nm, or especially at the edge of the visible range of from 390 to 430 nm, more especially approximately 405±5 nm. In the field of compact, blue or violet laser diodes (such as Nichia GaN 405 nm) with an optical system of high numerical aperture, the marks can be so small and the tracks so narrow that up to about 20 to 25 Gb per recording layer is achievable on a 120 mm disc. At 380 nm it is possible to use indium-doped UV-VCSELs (Vertical-Cavity Surface-Emitting Laser), which laser source already exists as a prototype [Jung Han et al., see MRS Internet J. Nitride Semicond. Res. 5S1, W6.2 (2000)].

The invention therefore relates also to a method of recording or playing back data, wherein the data on an optical recording medium according to the invention are recorded or played back at a wavelength of from 350 to 500 nm.

The recording medium is based on the structure of known recording media and is, for example, analogous to those mentioned above. It may be composed, for example, of a transparent substrate, a recording layer comprising at least one of the compounds of formula (I), a reflector layer and a covering layer, the writing and readout being effected through the substrate.

Suitable substrates are, for example, glass, minerals, ceramics and thermosetting and thermoplastic plastics. Preferred supports are glass and homo- or co-polymeric plastics. Suitable plastics are, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. Special preference is given to polycarbonate substrates which can be produced, for example, by injection-moulding. The substrate can be in pure form or may comprise customary additives, for example UV absorbers or dyes, as proposed e.g. in JP-A-04/167239 as light stabilisation for the recording layer. In the latter case it may be that in the range of the writing wavelength (emission wavelength of the laser) the dye added to the support substrate has no or at most only very low absorption, preferably up to a maximum of about 20% of the laser light focussed onto the recording layer.

The substrate is advantageously transparent over at least a portion of the range from 350 to 500 nm, so that it is permeable to, for example, at least 80% of the incident light of the writing or readout wavelength. The substrate is advantageously from 10 μm to 2 mm thick, preferably from 100 to 1200 μm thick, especially from 600 to 1100 μm thick, with a preferably spiral guide groove (track) on the coating side, a groove depth of from 10 to 200 nm, preferably from 80 to 150 nm, a groove width of from 100 to 400 nm, preferably from 150 to 250 nm, and a spacing between two turns of from 200 to 600 nm, preferably from 350 to 450 nm. Grooves of different cross-sectional shape are known, for example rectangular, trapezoidal or V-shaped. Analogously to the known CD-R and DVD-R media, the guide groove may additionally undergo a small periodic or quasi-periodic lateral deflection (wobble), so that synchronisation of the speed of rotation and the absolute positioning of the reading head (pick-up) are made possible. Instead of, or in addition to, the deflection, the same function can be performed by markings between adjacent grooves (pre-pits).

The recording medium is applied, for example, by application of a solution by spin-coating, the objective being to produce a layer that is as amorphous as possible, the thickness of which layer is advantageously from 0 to 40 nm, preferably from 1 to 20 nm, especially from 2 to 10 nm, on the surface (“land”) and, depending upon the geometry of the groove, advantageously from 20 to 150 nm, preferably from 50 to 120 nm, especially from 60 to 100 nm, in the groove.

Reflecting materials suitable for the reflector layer include especially metals, which provide good reflection of the laser radiation used for recording and playback, for example the metals of Main Groups 13-15 and of the Sub-Groups 3-12 of the Periodic Table of the Elements. Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt and the lanthanide metals Ce, Pr, Nd, Pm, Sm, Eu, Gd, Tb, Dy, Ho, Er, Tm, Yb and Lu and alloys thereof are especially suitable. On account of its high reflectivity and ease of production special preference is given to a reflective layer of aluminium, silver, gold or an alloy thereof (for example a white gold alloy), especially aluminium on economic and ecological grounds. The reflector layer is advantageously from 5 to 200 nm thick, preferably from 10 to 100 nm thick, especially from 40 to 60 nm thick, but reflector layers of greater thickness, for example 1 mm thick or even more, are also possible.

Materials suitable for the covering layer include chiefly plastics, which are applied in a thin layer to the reflector layer either directly or with the aid of adhesion promoters. It is advantageous to select mechanically and thermally stable plastics having good surface properties, which can be modified further, for example written on. The plastics may be thermosetting plastics and thermoplastic plastics. Directly applied covering layers are preferably radiation-cured (e.g. using UV radiation) coatings, which are particularly simple and economical to produce. A wide variety of radiation-curable materials are known. Examples of radiation-curable monomers and oligomers are acrylates and methacrylates of diols, triols and tetrols, polyimides of aromatic tetracarboxylic acids and aromatic diamines having C₁-C₄alkyl groups in at least two ortho-positions of the amino groups, and oligomers with dialkylmaleinimidyl groups, e.g. dimethylmaleinimidyl groups. For covering layers that are applied using adhesion promoters it is preferable to use the same materials as those used for the substrate layer, especially polycarbonates. The adhesion promoters used are preferably likewise radiation-curable monomers and oligomers. Instead of the covering layer applied using an adhesion promoter there may also be used a second substrate comprising a recording and reflector layer, so that the recording medium is playable on both sides. Preference is given to a symmetrical structure, the two parts being joined together at the reflector side by an adhesion promoter directly or by way of an intermediate layer.

In such a structure, the optical properties of the covering layer, or the covering materials, are essentially unimportant per se provided that, where applicable, curing thereof e.g. by UV radiation is achieved. The function of the covering layer is to ensure the mechanical strength of the recording medium as a whole and, if necessary, the mechanical strength of thin reflector layers. If the recording medium is sufficiently robust, for example when a thick reflector layer is present, it is even possible to dispense with the covering layer altogether. The thickness of the covering layer depends upon the thickness of the recording medium as a whole, which should preferably be a maximum of about 2 mm thick. The covering layer is preferably from 10 μm to 1 mm thick.

The recording media according to the invention may also have additional layers, for example interference layers or barrier layers. It is also possible to construct recording media having a plurality of (for example from two to ten) recording layers. The structure and the use of such materials are known to the person skilled in the art. Where present, interference layers are preferably arranged between the recording layer and the reflecting layer and/or between the recording layer and the substrate and consist of a dielectric material, for example as described in EP-A-0 353 393 of TiO₂, Si₃N₄, ZnS or silicone resins.

The recording media according to the invention can be produced by processes known per se, it being possible for various methods of coating to be employed depending upon the materials used and their function.

Suitable coating methods are, for example, immersion, pouring, brush-coating, blade-application and spin-coating, as well as vapour-deposition methods carried out under a high vacuum. When, for example, pouring methods are used, solutions in organic solvents are generally employed. When solvents are employed, care should be taken that the supports used are insensitive to those solvents. Suitable coating methods and solvents are described, for example, in EP-A-0 401 791.

The recording layer is applied preferably by the application of a dye solution by spin-coating, solvents that have proved satisfactory being especially alcohols, e.g. 2-methoxyethanol, isopropanol or n-butanol, hydroxyketones, for example diacetone alcohol or 3-hydroxy-3-methyl-2-butanone, hydroxy esters, for example lactic acid methyl ester or isobutyric acid methyl ester, or preferably fluorinated alcohols, for example 2,2,2-trifluoroethanol or 2,2,3,3-tetrafluoro-1 -propanol, and mixtures thereof. Further suitable solvents are well-known in the art and disclosed, for example, in EP-A-0 483 387.

The application of the metallic reflector layer is preferably effected by sputtering or by vapour-deposition in vacuo. Such techniques are known and are described in specialist literature (e.g. J. L. Vossen and W. Kern, “Thin Film Processes”, Academic Press, 1978). The operation can advantageously be carried out continuously and achieves good reflectivity and a high degree of adhesiveness of the metallic reflector layer.

Recording is carried out in accordance with known methods by writing pits (marks) of fixed or variable length by means of a modulated, focussed laser beam guided at a constant or variable speed over the surface of the recording layer. Readout of information is carried out according to methods known per se by registering the change in reflection using laser radiation, for example as described in “CD-Player und R-DAT Recorder” (Claus Biaesch-Wiepke, Vogel Buchverlag, Würzburg 1992).The person skilled in the art will be familiar with the requirements.

The information-containing medium according to the invention is especially an optical information material of the WORM type. It can be used, for example, analogously to CD-R (compact disc-recordable) or DVD-R (digital video disc-recordable) in computers, and also as storage material for identification and security cards or for the production of diffractive optical elements, for example holograms.

Alternatively, however, there are also recording media which differ substantially from CD-R and DVD-R and in which recording and playback take place not through the substrate but through the covering layer (“in-groove recording”). Accordingly, the respective roles of the covering layer and the substrate, especially the geometry and the optical properties, are reversed in comparison with the structure described above. Analogdus concepts are described a number of times in Proceedings SPIE-Int. Soc. Opt. Eng. 1999. 3864 for digital video recordings in conjunction with a blue GaN laser diode. For such recording media, which are especially suitable for a high storage density and have correspondingly small marks (“pits”), precise focussing is important, so that the manufacturing process, while essentially analogous, is considerably more awkward.

The compounds of formula (I) according to the invention, however, also meet the increased demands of an inverse layer structure surprisingly well. Preference is therefore given to an inverse layer structure having the layer sequence substrate, reflector layer, recording layer and covering layer. The recording layer is therefore located between the reflector layer and the covering layer. A thin covering layer approximately from 50 to 400 μm in thickness is especially advantageous (typically 100 μm at a numerical aperture of 0.85).

The recording and reflector layers in an inverse layer structure have in principle the same functions as indicated above. As with the groove geometry, they therefore usually have dimensions within the ranges indicated above.

The inverse layer structure requires particularly high standards, which the compounds used according to the invention fulfil astonishingly well, for example when the recording layer is applied to the metallic reflector layer and especially when a covering layer is applied to the recording layer, the covering layer being required to provide the recording layer with adequate protection against rubbing, photo-oxidation, fingerprints, moisture and other environmental effects and advantageously having a thickness in the range of from 0.01 to 0.5 mm, preferably in the range of from 0.05 to 0.2 mm, especially in the range of from 0.08 to 0.13 mm.

The covering layer preferably consists of a material that exhibits a transmission of 80% or above at the writing or readout wavelength of the laser. Suitable materials for the covering layer include, for example, those materials mentioned above, but especially polycarbonate (such as Pure Ace® or Panlite®, Teijin Ltd), cellulose triacetate (such as Fujitac®, Fuji Photo Film) or polyethylene terephthalate (such as Lumirror®, Toray Industry), special preference being given to polycarbonate. Especially in the case of directly applied covering layers, radiation-cured coatings, such as those already described above, are advantageous, for example SD 347™ (Dainippon Ink).

The covering layer can be applied directly to the solid recording layer by means of a suitable adhesion promoter. In another embodiment, there is applied to the solid recording layer an additional, thin separating layer of a metallic, crosslinked organometallic or preferably dielectric inorganic material, for example in a thickness of from 0.001 to 10 μm, preferably from 0.005 to 1 μm, especially from 0.01 to 0.1 μm, for example from 0.05 to 0.08 μm in the case of dielectric separating layers and from 0.01 to 0.03 μm in the case of metallic separating layers. Separating layers and corresponding methods are disclosed in WO 02/082438, to which reference is expressly made here. If desired, such coatings can be applied, for example, in the same thickness also between the support material and the metallic reflector layer or between the metallic reflector layer and the optical recording layer. This may be advantageous in certain cases, for example when a silver reflector is used in combination with sulfur-containing additives in the recording layer.

In a special variant, there is applied to the solid recording layer an additional, thin separating layer of a metallic, crosslinked organometallic or dielectric inorganic material, for example in a thickness of from 0.001 to 10 μm, preferably from 0.005 to 1 μm, especially from 0.01 to 0.1 μm. On account of their high reflectivity, metallic separating layers should advantageously be a maximum of 0.03 μm thick. Separating layers and corresponding methods are disclosed in WO 02/082438, to which reference is expressly made here.

The compounds of formula (I), (II), (III) or (IV) used according to the invention are new, but easy to be made from known compounds by known methods, such as in analogy to J. Org. Chem. 67/16, 5753-5772 [2002].

The invention therefore relates also to compounds of formula (I).

Especially interesting properties are exhibited by mixtures of compounds of instant formula (I) as well as by mixtures of one or more compounds of instant formula (I) with one or more compounds according to formula (I), (II), (III), (IV) and/or (V) of PCT/EP 2004/050 185.

Instead of preparing mixtures by mixing together the components, it is favourably possible to prepare mixtures by mixed synthesis, the metals being added in any desired order in succession or preferably simultaneously to a pre-prepared mixture of the ligands, or conversely the ligands being added in any desired order in succession or preferably all of them simultaneously to a pre-prepared mixture of the metals. The mixtures prepared by mixed synthesis generally have somewhat better solubility than physical mixtures, possibly because of their asymmetric components.

In addition to comprising one or more compounds of formula (I) and optionally customary additives, the optical recording media according to the invention may also comprise other chromophores, preferably metal-free chromophores. Other chromophores may, if desired, be added in an amount of from 1 to 200% by weight, based on the total of the compounds of formula (I). The amount of other chromophores is preferably from 5 to 100% by weight, especially from 10 to 50% by weight, based on the total of the compounds of formula (I). Chromophores can be dyes or UV absorbers, preferably having an absorption maximum of from 350 to 400 nm or at from 600 to 700 nm, for example around 380 or 630 nm.

Especially preferred additional metal-free chromophores are cyanines, azacyanines, merocyanines and oxonols and also rhodamines, for example those disclosed in WO 04/006878, WO 02/082438 or EP-A-1 083 555, and also 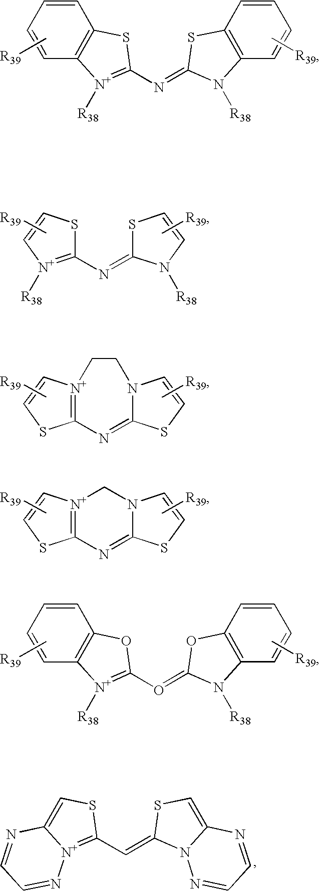
wherein R₃₈ is C₁-C₂₄alkyl or C₂-C₂₄alkenyl, each of which can be unsubstituted or substituted, and R₃₉ is any substituent. R₃₈ may be, for example, methyl, ethyl, vinyl, allyl, isopropyl, n-butyl, 2-isopropyloxy-ethyl, n-pentyl, 3-methyl-butyl, 3,3-dimethylbutyl, 2-ethyl-hexyl, 2-cyano-ethyl, furan-2-yl-methyl or 2-hydroxy-methyl; R₃₉ is, for example, C₆-C₁₀aryl, C₁-C₂₄alkyl or C₂-C₂₄alkenyl. Purely illustrative examples of such chromophoes are:

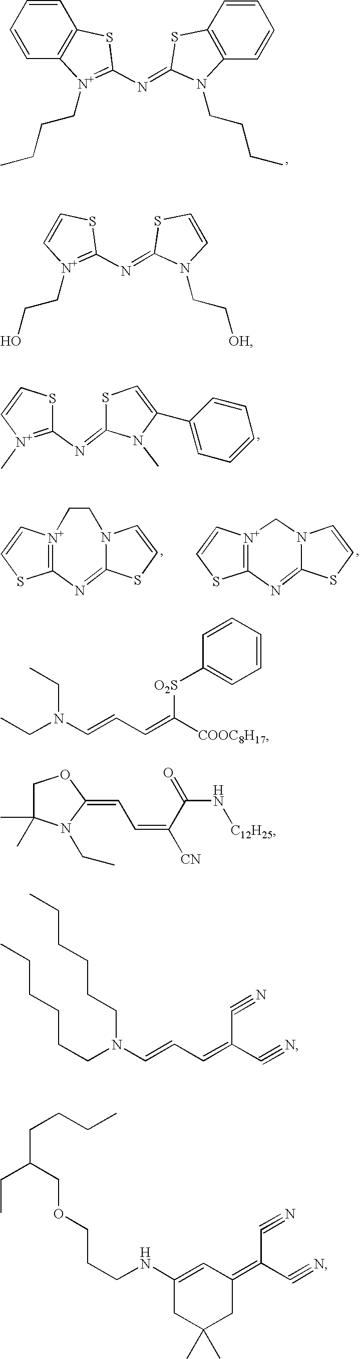

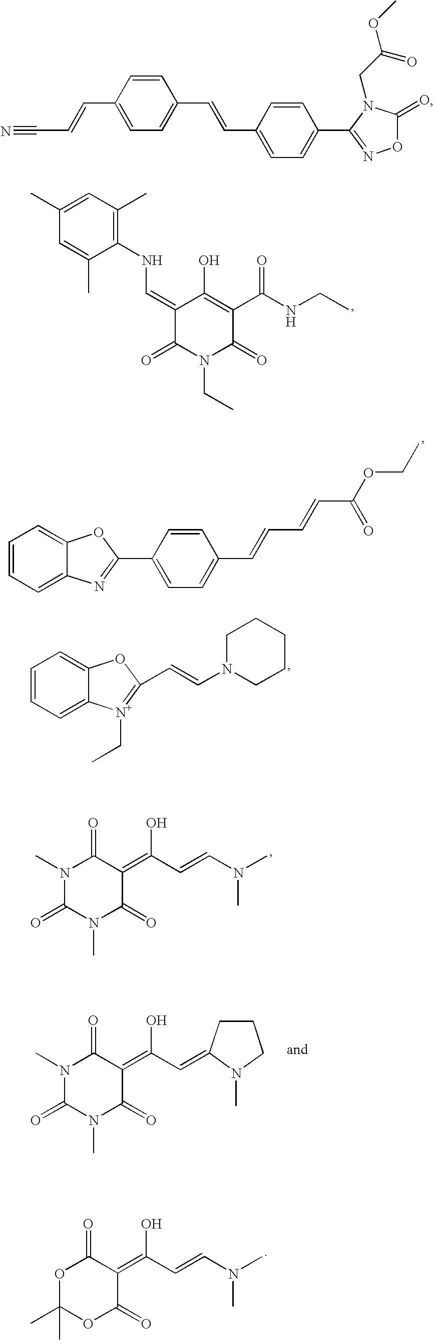

The following examples illustrate the invention but do not limit the scope thereof (unless otherwise indicated, “%” always refers to % by weight):

### EXAMPLE 1

A solution of 249 mg cobalt(II) acetate tetrahydrate in 13 ml ethanol is added to a solution of 465 mg 2-(4-isopropylthiazolyl)aminothiazole in 13 ml ethanol. The mixture is stirred for 70 hours at ˜23° C. in the presence of air. The solution color changes from orange to purple, and finally turns dark blue. The solvent is removed under reduced pressure to give a dark blue residue. Small amounts of methanol and ethanol are added to the residue. The precipitate is collected by filtration, washed with small amount of cold ethanol and dried at 50° C./1.2·10³ Pa. 170 mg crude product are thus obtained as an isomeric mixture (ratio 6:4) of following formula:

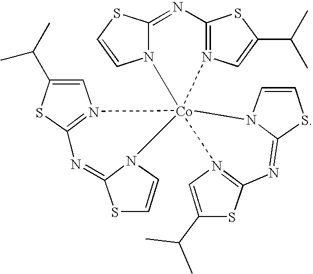

### EXAMPLE 2

The product of following formula is obtained in close analogy to example 1: 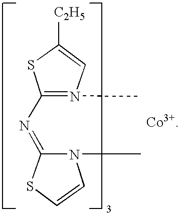
¹H-NMR (CDCl₃): 1.1-1.2 (m, 9H), 2.5-2.6 (m, 6H), 5.80-5.92 (m, 3H), 6.18-6.28 (m, 3H), 6.40-6.45 (m, 3H).

### EXAMPLE 3

The product of following formula is obtained in close analogy to example 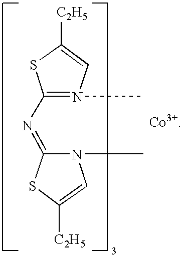
¹H-NMR (CDCl₃): 1.13 (t, 9H), 2.55 (q, 6H), 5.85 (s, 3H).

### EXAMPLE 4

The product of following formula is obtained in close analogy to example 1: 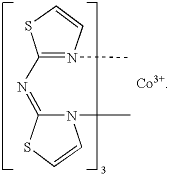
UV/VIS (dichloromethane): λₘₐₓ=361 nm, ε=90514 I·mol⁻¹·cm⁻¹; ¹H-NMR (DMSO-d₆): 6.08 (d, 6H), 6.90 (d, 6H).

### EXAMPLE 5

The product of following formula is obtained in close analogy to example 1: 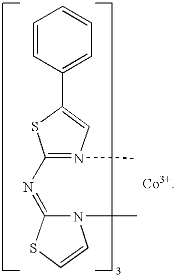
¹H-NMR (CDCl₃): 6.30-6.67 (m, 9H), 7.19-7.35 (m, 15H).

### EXAMPLE 6

The product of following formula is obtained in close analogy to example 1: 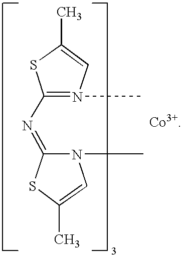
UV/VIS (dichloromethane): λₘₐₓ=367 nm, ε=58 100 I·mol⁻¹·cm⁻¹; MS: m/e=689.

### EXAMPLE 7

The product of following formula is obtained in close analogy to example 1: 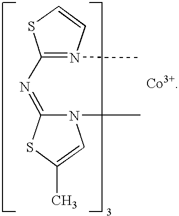
MS: m/e=647.

### EXAMPLE 8

### The product of following formula is obtained in close analogy to example 1:

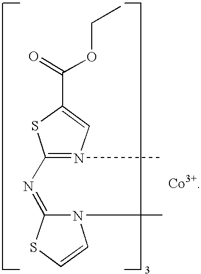 ¹H-NMR (CDCl₃): 1.25-1.33 (m, 9H): 4.20-4.31 (m, 6H), 6.21-6.45 (d x4, 3H), 6.62-6.93 (m, 6H).

### EXAMPLE 9

The product according to example 1 (170 mg) is separated into its two isomers by silica gel column chromatography (eluent: ethyl acetate/n-hexane 2:1 by vol.).

The lower polarity isomer (yield 90 mg) has following data: H-NMR (DMSO-d₆): 1.05 (m,18H), 2.80 (m,3H), 5.46 (m,1 H), 5.58 (m,1 H), 5.70 (m,1H), 6.05 (m,1H), 6.11 (m,1H), 6.84-6.88 (m,3H).

The higher polarity isomer (yield 60 mg) has following data: ¹H-NMR (CDCl₃): 1.14 (m,6H), 2.87 (m,1H), 5.82 (d,1H), 6.17 (d,1 H), 6.42 (d,1H).

### EXAMPLE 10

The product of following formula is obtained in close analogy to example 1:

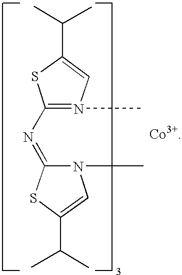

¹H-NMR (CDCl₃): 1.14 (m, 36H), 2.84 (m, 6H), 5.74 (s, 6H).

### EXAMPLE 11

The product of following formula is obtained in close analogy to examples 1 and 10, but starting with a 1:1 mixture of bis(2-thiazolyl)amine and bis(4-isopropyl-2-thiazolyl)amine:

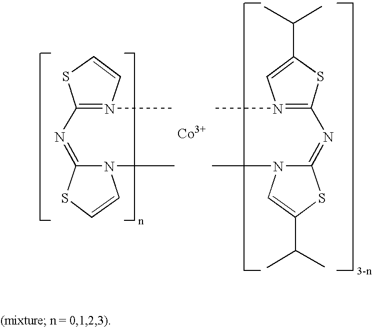

TLC (CH₂Cl₂-acetone=20:1 as eluent) of this mixture shows 4 colored spots, and the spot of the lowest polarity corresponds to the compound of example 10.

¹H-NMR (DMSO-d₆): 1.04-1.10 (m), 2.8-2.9 (m), 5.57-6.10 (m), 6.88-6.93 (m).

### EXAMPLES 12-13

The pure isomers of the mixture according to Example 1 (isolated according to Example 9) are each dissolved in the 100-fold quantity of 2,2,3,3-tetrafluoro-1-propanol and spin-coated onto a 1.2 mm thick, flat polycarbonate plate (diameter 120 mm). The pale blue solid layer is measured using an optical measuring system (ETA-RT™ Disc Analysing System, STEAG ETA-Optik). The refractive index is determined at a wavelength of 405 nm. Alternatively, the compounds may be spin-coated onto a silicon wafer and the solid layer measured using a spectral ellipsometer (Sopra).

The lower polarity isomer has following data: n=2.118, k=0.034.

The higher polarity isomer has following data: n=2.142, k=0.044.

### EXAMPLE 14

100 mg of the isomeric mixture according to example 1 is dissolved in 12.0 g of 2,2,3,3-tetrafluoro-1-propanol and filtered through a 0.2 μm Teflon filter. The dye solution is then applied by rotation at 250 rev/min to a 1.2 mm thick, flat polycarbonate plate (diameter 120 mm). The rotational speed is then increased to 1200 rev/min, so that the excess solution is spun off, and a uniform solid layer is formed. After drying, the solid layer has an absorption of 0.44 at 371 nm. Using an optical measuring system (ETA-RT™, STEAG ETA-Optik), the layer thickness and the complex refractive index are determined. At 405 nm the dye layer has a layer thickness of 34 nm, a refractive index n of 2.12 and an extinction coefficient k of 0.030.

### EXAMPLE 15

In a vacuum-coating apparatus (Twister™, Balzers Unaxis), a 30 nm thick silver reflector layer is applied onto a 1.1 mm thick grooved polycarbonate disc (diameter 120 mm, groove pitch 400 nm, groove depth 80 nm, groove width 170 nm). 40 mg of the isomeric mixture according to example 1 are dissolved in 1 ml 2,2,3,3-tetrafluoro-1-propanol and filtered through a 0.2 μm Teflon™ filter. The dye solution is applied onto the reflector layer by the spin-coating method in order to form a uniform solid layer. Optionally, a 40 nm thick dielectric layer (SiON) may successively be applied by RF-sputtering in a vacuum-coating apparatus (Cube™, Balzers Unaxis). A polycarbonate film covered on one side with a pressure-sensitive adhesive (total thickness 100 μm, Lintec Corp., Japan) is finally bonded onto the dielectric layer. Using a commercial disc testing equipment (ODU-1000™ for Blu-ray® Disc, Pulstec, Japan) based on a 407 nm laser diode and an objective lens numerical aperture of 0.85, marks are recorded on the disc with a linear speed of 5.28 m/s and a laser power of 7 mW. The recorded area is then successfully read back with 0.35 mW laser power.

### EXAMPLE 16

In a vacuum-coating apparatus (Twister™, Balzers Unaxis), a 50 nm thick silver reflector layer is applied onto a 1.1 mm thick grooved polycarbonate disc (diameter 120 mm, groove pitch 320 nm, groove depth 21 nm, groove width 150 nm). 14 mg of the compound according to example 2 are dissolved in 1 ml 2,2,3,3-tetrafluoro-1-propanol and filtered through a 0.2 μm Teflon™ filter. The dye solution is applied onto the reflector layer by the spin-coating method in order to form a uniform solid layer. Optionally, a 40 nm thick dielectric layer (SiON) may successively be applied by RF-sputtering in a vacuum-coating apparatus (Cube™, Balzers Unaxis). A polycarbonate film covered on one side with a pressure-sensitive adhesive (total thickness 100 μm, Lintec Corp., Japan) is finally bonded onto the dielectric layer. Using a commercial disc testing equipment (ODU-1000™ for Blu-ray® Disc, Pulstec, Japan) based on a 407 nm laser diode and an objective lens numerical aperture of 0.85, marks are recorded on the disc with a linear speed of 5.28 m/s and a laser power of 1.5 mW. The recorded area is then successfully read back with 0.3 mW laser power.

1. An optical recording medium comprising a substrate, a recording layer and optionally one or more reflecting layers, wherein the recording layer comprises a compound of formula 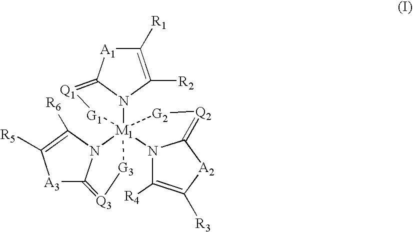
or a tautomer thereof, wherein
G₁, G₂ and G₃ are each independently of the other 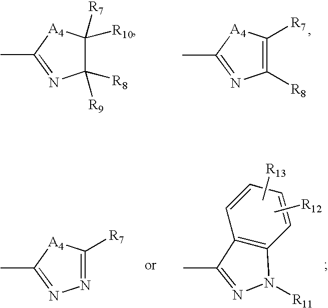
A₁, A₂ and A₃ are each independently of the other N(R₁₄), O, S or Se and A₄ is C(C₁-C₅alkyl)₂, C(C₄-C₅alkylene), N(R₁₄), O, S, Se, N═C(R₁₅) or CH═C(R₁₆);
M₁ is an at least trivalent metal of groups 3 to 15 [formerly groups IIIA to VB];
R₁, R₂, R₃, R₄, R₅, R₆, R₇, R₈, R₉, R₁₀ and R₁₆ are each independently of the others hydrogen, R₁₈, or C₆-C₁₂aryl, C₄-C₁₂heteroaryl, C₇-C₁₂aralkyl or C₅-C₁₂heteroaralkyl each unsubstituted or substituted by one or more, where applicable identical or different, radicals R₁₈; or
R₁ and R₂, R₃ and R₄, R₅ and R₆, R₇ and R₈, R₇ and R₁₅ and/or R₇ and R₁₆, together in pairs, are C₃-C₆alkylene or C₃-C₆alkenylene, each of which is unsubstituted or substituted by one or more, where applicable identical or different, radicals R₁₉ and may be uninterrupted or interrupted by O, S or N(R₁₄), or 1,4-buta-1,3-dienylene, 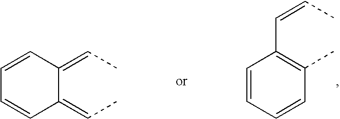
each of which is unsubstituted or substituted by one or more, where applicable identical or different, radicals R,₈ and in which 1 or 2 carbon atoms may have been replaced by nitrogen;
R₁₁, R₁₄ and R₁₅ are each independently of the others C₁-C₂₄alkyl, C₃-C₂₄cycloalkyl, C₂-C₂₄alkenyl, C₃-C₂₄cycloalkenyl, C₁-C₄alkyl-[O-C₁-C₄alkylene]ₘ or C₁-C₄alkyl-[NH-C₁-C₄alkylene]ₘ, each of which is unsubstituted or substituted by one or more, where applicable identical or different, radicals R₁₉; or C₆-C₁₂aryl, C₄-C₁₂heteroaryl, C₇-C₁₂aralkyl or C₅-C₁₂heteroaralkyl, each of which is unsubstituted or substituted by one or more, where applicable identical or different, radicals R₁₈;
R₁₂, R₁₃ and R₁₈ are each independently of the others R₂₀ or C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each unsubstituted or substituted by one or more, where applicable identical or different, radicals R₁₉;
R₁₇ is hydrogen, halogen, cyano, hydroxy, C₁-C₁₂alkoxy, C₃-C₁₂cycloalkoxy, C₁-C₁₂alkylthio, C₃-C₁₂cycloalkylthio, amino, nitro, formyl, C(R₁₆)═CR₂₁R₂₂, C(R₁₆)═NR₂₃, N═CR₂₃R₂₄, NHR₂₅, NR₂₆R₂₇, COO—R₂₆, carboxy, carbamoyl, CONH—R₂₆, CONR₂₆R₂₇, R₂₈, N═N—R₂₈ or R₂₉;
R₁₉ is halogen, hydroxy, O—R₂₆, O—CO—R₂₆, S—R₂₆, NH₂, NH—R₂₆, NR₂₆R₂₇, NH₃⁺, NH₂R₂₆⁺, NHR₂₆R₂₇⁺. NR₂₅R₂₆R₂₇⁺, NR₂₆—CO—R₂₅, NR₂₆COOR₂₅, cyano, formyl, COO—R₂₆, carboxy, carbamoyl, CONH—R₂₆, CONR₂₆R₂₇, ureido, NH—CO—NHR₂₅, NR₂₆—CO—NHR₂₅, phosphato, PR₂₅R₂₆, POR₂₅OR₂₆, P(═O)OR₂₅OR₂₆, OPR₂₅R₂₆, OPR₂₅OR₂₆, OP(═O)OR₂₅OR₂₆, OPO₃R₂₆, OP(═O)OR₂₅OR₂₆, SO₂R₂₆, sulfato, sulfo, R₂₈, N═N—R₂₈, or C₁-C₁₂alkoxy or C₁-C₁₂cycloalkoxy each unsubstituted or mono- or poly-substituted by halogen;
R₂₀ is halogen, nitro, cyano, thiocyanato, hydroxy, O—R₂₃, O—CO—R₂₃, S—R₂₃, CHO, COR₂₄, CHOR₂₃OR₃₀, CR₂₄OR₂₃OR₃₀, R₃₁, N═N—R₃₁, N═CR₂₃R₂₄, N═CR₂₁R₂₂, C(R₃₂)═NR₂₃, C(R₃₂)═NR₂₁, C(R₃₂)═CR₂₁R₂₂, NH₂, NH—R₂₃, NR₂₃R₂₄, NH₃⁺, NH₂R₂₃⁺, NHR₂₃R₂₄⁺, NR₂₃R₂₄R₃₀⁺, CONH₂, CONHR₂₃, CONR₂₃R₂₄, SO₂R₂₃, SO₂NH₂, SO₂NHR₂₃, SO₂NR₂₃R₂₄, COOH, COOR₂₃, OCOOR₂₃, NHCOR₂₃, NR₂₃COR₃₀, NHCOOR₂₃, NR₂₃COOR₃₀, ureido, NR₂₃—CO—NHR₃₀, B(OH)₂, B(OH)(OR₂₃), B(OR₂₃)OR₃₀, phosphato, PR₂₃R₃₀, POR₂₃OR₃₀, P(═O)OR₂₃OR₃₀, OPR₂₃R₃₀, OPR₂₃OR₃₀, OP(═O)R₂₃OR₃₀, OP(═O)OR₂₃OR₃₀, OPO₃R₂₃, sulfato or sulfo;
R₂₁, and R₂₂ are each independently of the other NR₂₆R₂₇, CN, CONH₂, CONHR₂₃, CONR₂₃R₂₄ or COOR₂₄;
R₂₃, R₂₄ and R₃₀ are each independently of the others R₃₁, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₂alkoxy or C₃-C₁₂cycloalkoxy radicals; or R₁₆ and R₂₃ together, R₁₇ and R₂₃ together and/or R₂₃ and R₃₀ together are C₂-C₁₂alkylene, C₃-C₁₂cycloalkylene, C₂-C₁₂alkenylene or C₃-C₁₂cycloalkenylene, each of which is unsubstituted or substituted by one or more, where applicable identical or different, halogen, hydroxy, C₁-C₁₂alkoxy or C₃-C₁₂cycloalkoxy radicals; or
R₂₃ and R₂₄ together with the common nitrogen are pyrrolidine, piperidine, piperazine or morpholine, each of which is unsubstituted or mono- to tetra-substituted by C₁-C₄alkyl; or carbazole, phenoxazine or phenothiazine, each of which is unsubstituted or substituted by one or more, where applicable identical or different, radicals R₃₃;
R₂₅, R₂₆ and R₂₇ are each independently of the others C₁-C₁₂alkyl, C₃-C₁₂cycloalkyl, C₂-C₁₂alkenyl, C₃-C₁₂cycloalkenyl, C₆-C₁₂aryl, C₄-C₁₂heteroaryl, C₇-C₁₂aralkyl or C₅-C₁₂heteroaralkyl; or
R₂₆ and R₂₇ together with the common nitrogen are pyrrolidine, piperidine, piperazine or morpholine, each of which is unsubstituted or mono- to tetra-substituted by C₁-C₄alkyl;
R₂₈ is C₆-C₁₂aryl, C₄-C₁₂heteroaryl, C₇-C₁₂aralkyl or C₅-C₁₂heteroaralkyl, each of which is unsubstituted or substituted by one or more, where applicable identical or different, radicals R₂₀ or R₂₉;
R₂₉ is C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals;
R₃₁ is C₆-C₁₂aryl, C₄-C₁₂heteroaryl, C₇-C₁₂aralkyl or C₅-C₁₂heteroaralkyl, each of which is unsubstituted or substituted by one or more, where applicable identical or different, radicals R₃₃;
R₃₂ is hydrogen, cyano, hydroxy, C₁-C₁₂alkoxy, C₃-C₁₂cycloalkoxy, C₁-C₁₂alkylthio, C₃-C₁₂cycloalkylthio, amino, NHR₂₅, NR₂₆R₂₇, R₂₈, halogen, nitro, formyl, N═N—R₂₈, COO—R₂₆, carboxy, carbamoyl, CONH—R₂₆, CONR₂₆R₂₇, N═CR₂₃R₂₄, or C₁-C₁₂alkyl, C₃-C₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals;
R₃₃ is nitro, SO₂NHR₂₆, SO₂NR₂₆R₂₇, or C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each unsubstituted or substituted by one or more, where applicable identical or different, radicals R₁₉; and
m is a number from 1 to 10.

2. An optical recording medium according to claim 1, wherein M1 is a trebly positively charged cation.

3. An optical recording medium according to claim 1, wherein the recording layer comprises a compound of formula (I) wherein
A₁, A₂, A₃ and A₄ are each independently of the others O, S or N(R₁₄) and/or Q₁, Q₂ and Q₃ are C(R₁₇) or N;
G₁, G₂ and G₃ are each independently of the other 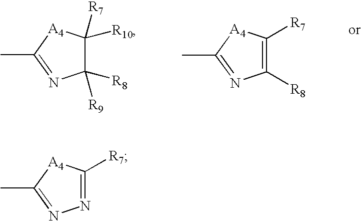
R₁, R₃, R₅, R₇, R₁₀ and R₁₆ are each independently of the others hydrogen, R₁₈, or C₆-C₁₂aryl or C₇-C₁₂aralkyl each unsubstituted or substituted by one or more, where applicable identical or different, radicals R₁₈;
R₂, R₄, R₆, R₈ and R₉ are each independently of the others H, F, OH, OCH₃, OCF₃, CH₃, CF₃, C₂H₅, C₂H₂F₃, C₂H₃F₂, C₂F₅, CH₂OH, CF₂OH or CH₂OCH₃;
R₁₄ and R₁₅ are each independently of the others unsubstituted or R₁₉-substituted C₁-C₈alkyl;
R₁₂ and R₁₈ are each independently of the other halogen, nitro, cyano, O—R₂₃, CHO, CH═C(CN)₂, CH═C(CN)CONH₂, CH═C(CN)CONHR₂₃, CH═C(CN)CONR₂₃R₂₄, CH═C(CN)COOR₂₃, CH═C(COOR₂₃)COOR₂₄, CONH₂, CONHR₂₃, CONR₂₃R₂₄, SO₂C₁-C₁₂alkyl, SO₂NH₂, SO₂NHR₂₃, SO₂NR₂₃R₂₄, COOH, COOR₂₃, NHCOR₂₃, NR₂₃COR₃₀, NHCOOR₂₃, NR₂₃COOR₃₀, ureido, P(═O)OR₂₃OR₃₀, sulfo, or C₁-C₁₂alkyl, C₁-C₁₂alkylthio or C₁-C₁₂alkoxy each unsubstituted or substituted by one or more, where applicable identical or different, radicals R₁₉;
R₁₇ is hydrogen, halogen, cyano, nitro, formyl, C(R₁₆)═CR₂₁R₂₂, C(R₁₆)═NR₂₃, COO—R₂₆, carboxy, carbamoyl, CONH—R₂₆, CONR₂₆R₂₇, N═N—R₂₈, or C₁-C₁₂alkyl unsubstituted or substituted by one or more halogen substituents;
R₁₉ is halogen, hydroxy, O—R₂₆, NH₂, NH—R₂₆, NR₂₆R₂₇, NR₂₆—CO—R₂₅, NR₂₆COOR₂₅, cyano, COO—R₂₆, carboxy, CONH—R₂₆, CONR₂₆R₂₇, sulfato, sulfo, or C₁-C₁₂alkoxy unsubstituted or mono- or poly-substituted by halogen;
R₂₃, R₂₄ and R₃₀ are each independently of the others C₁-C₁₂alkyl unsubstituted or substituted by one or more, where applicable identical or different, halogen, hydroxy or C₁-C₁₂alkoxy radicals, or unsubstituted C₆-C₁₂aryl or C₇-C₁₂aralkyl; or R₂₃ and R₂₄ together with the common nitrogen are morpholine, or piperidine N-substituted by C₁-C₄alkyl;
R₂₅, R₂₆ and R₂₇ are each independently of the others C₁-C₁₂alkyl, C₂-C₁₂alkenyl, C₆-C₁₂aryl or C₇-C₁₂aralkyl; or R₂₆ and R₂₇ together with the common nitrogen are morpholine, or piperidine N-substituted by C₁-C₄alkyl;
R₃₁ is unsubstituted or substituted C₆-C₁₂aryl or C₇-C₁₂aralkyl; and/or
m is a number from 1 to 4.

4. An optical recording medium according to claim 1, wherein the recording layer comprises a compound of formula (I) wherein Q₁, Q₂ and Q₃ are C(R₁₇); G₁, G₂ and G₃ are 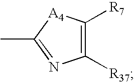
and A₁, A₂, A₃ and A₄ are O, S or N(R₁₄);
R₁₄ is C₁-C₂₄alkyl, C₁-C₄alkyl—[O-C₁-C₄alkylene]ₘ or C₁-C₄alkyl—[NH-C₁-C₄alkylene]ₘ, each of which is unsubstituted or substituted by one or more, where applicable identical or different, radicals R₁₉, or C₆-C₁₂aryl unsubstituted or substituted by one or more, where applicable identical or different, radicals R₁₈;
R₁₇ is hydrogen, cyano, COO—R₂₆ or C₁-C₁₂alkyl;
R₁₈ is halogen, nitro, cyano, O—R₂₃, CH═C(CN)₂, COOR₂₃, ureido, CONR₂₆R₂₇, SO₂R₂₆, P(═O)OR₂₃OR₃₀ or unsubstituted or substituted C₁-C₁₂alkyl; R₁₉ is halogen, hydroxy, O—R₂₆, cyano, COO—R₂₆ or carboxy; and R₃₇ is H, methyl, ethyl or isopropyl.

5. An optical recording medium according to claim 1, wherein the recording layer comprises a compound of formula (I) wherein

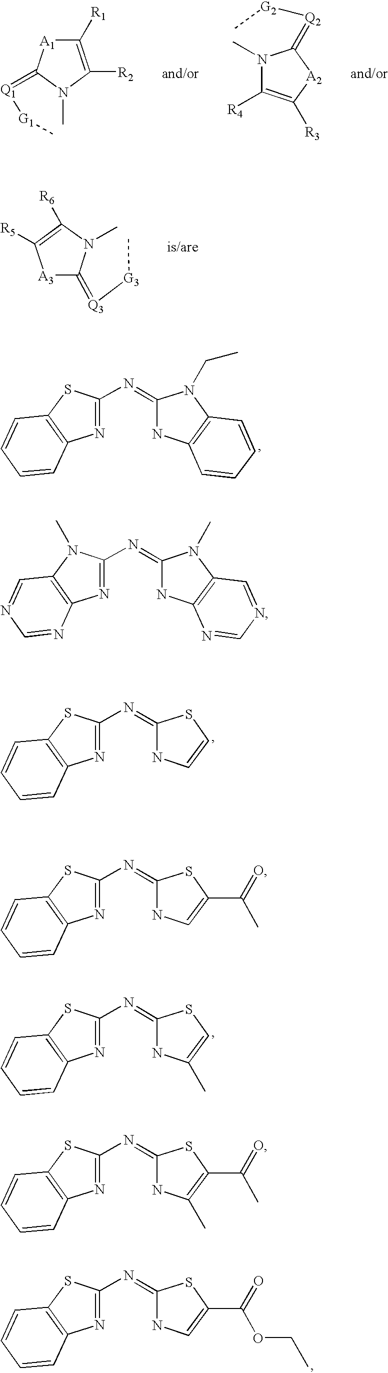

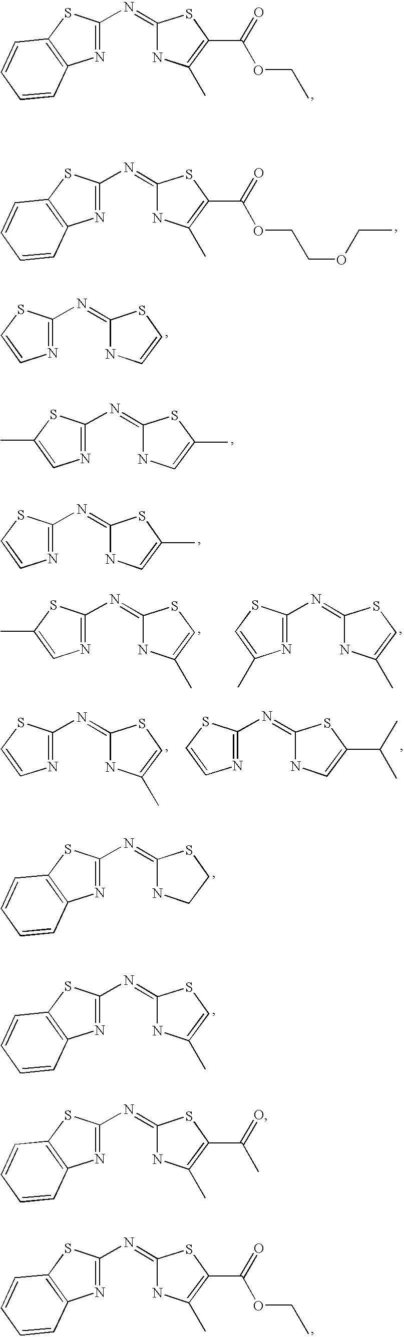

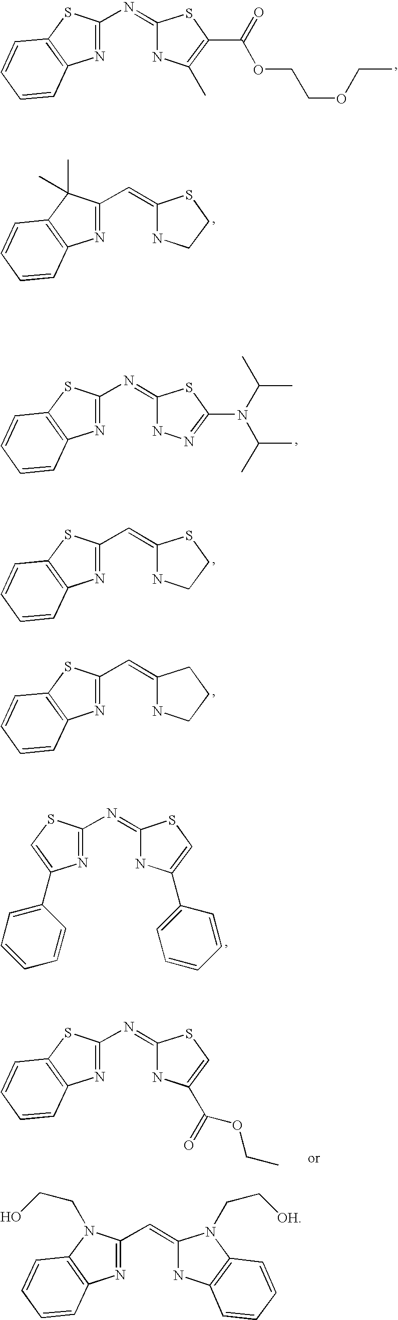

6. An optical recording medium according to claim 1, wherein the recording layer is substantially amorphous.

7. An optical recording medium according to claim 1, additionally comprising a covering layer, wherein substrate, reflector layer, recording layer and covering layer are arranged in that order.

8. An optical recording medium according to claim 1, which in addition to comprising a compound of formula (I) comprises a metal-free chromophore.

9. A method of recording or playing back data, wherein the data on an optical recording medium according to claim 1, are recorded or played back at a wavelength of from 350 to 500 nm.

10. A compound of formula (I) according to claim 1.

11. A compound according to claim 10, wherein R₂, R₄, R₆, R₈, R₉ and R₁₁ are hydrogen.

12. A method of for optical recording, wherein the data is recorded on an optical recording medium containing a compound according to claim 10 at a wavelength of from 350 to 500 nm.

13. An optical recording medium according to claim 1, wherein in formula (I) M₁ is Co(III), Cr(III), Ru(III), Fe(III), Mn(III), V(III), Ti(III), Y(III), Mo(III), W(III), Nb(III), Rh(III), Ta(III), Ir(III), Au(III), Al(III), As(III), Sb(III), Bi(III), Sc(III), La(III), Ce(III), Pr(III), Nd(III), Pm(III), Sm(III), Eu(III), Gd(III), Tb(III), Dy(III), Ho(III), Er(III), Tm(III), Yb(III) or Lu(III).

14. An optical recording medium according to claim 13, wherein M₁ is Co(III) or Cr(III).

15. An optical recording medium according to claim 3, wherein R₃₁ is unsubstituted or substituted especially a metallocenyl radical.

16. An optical recording medium according to claim 3, wherein in formula (I) M₁ is Co(III), Cr(III), Ru(IIIl), Fe(III), Mn(III), V(III), Ti(III), Y(III), Mo(III), W(III), Nb(III), Rh(III), Ta(III), Ir(III), Au(III), Al(III), As(III), Sb(III), Bi(III), Sc(III), La(III), Ce(III), Pr(III), Nd(III), Pm(III), Sm(III), Eu(III), Gd(III), Tb(III), Dy(III), Ho(III), Er(III), Tm(III), Yb(III) or Lu(III).

17. An optical recording medium according to claim 15, wherein M₁ is Co(III) or Cr(III).

18. An optical recording medium according to claim 4, wherein in formula (I) M₁ is Co(III), Cr(III), Ru(III), Fe(III), Mn(III), V(ll), Ti(III), Y(III), Mo(III), W(III), Nb(III), Rh(III), Ta(III), Ir(III), Au(III), AI(III), As(III), Sb(III), Bi(III), Sc(III), La(III), Ce(III), Pr(III), Nd(III), Pm(III), Sm(III), Eu(III), Gd(III), Tb(III), Dy(III), Ho(III), Er(III), Tm(III), Yb(III) or Lu(III).

19. An optical recording medium according to claim 5, wherein in formula (I) M₁ is Co(III), Cr(III), Ru(III), Fe(III), Mn(III), V(III), Ti(III), Y(III), Mo(III), W(III), Nb(III), Rh(III), Ta(III), Ir(III), Au(III), Al(III), As(III), Sb(III), Bi(III), Sc(III), La(III), Ce(III), Pr(III), Nd(III), Pm(III), Sm(III), Eu(III), Gd(III), Tb(III), Dy(III), Ho(III), Er(III), Tm(III), Yb(III) or Lu(III).
